(19) United States
(12) Patent Application Publication
(10) Pub. No.: US 2004/0146059 A1
(43) Pub. Date: Jul. 29, 2004

(54) Method for controlling the bandwidth of a bridge device

(76) Inventor: Fang Cheng Liu, Hsinchu (TW)

Correspondence Address: SEYFARTH SHAW, 55 EAST MONROE STREET, SUITE 4200, CHICAGO, IL, 60603-5803, US

(21) Appl. No.: 10/422,178

(22) Filed: Apr. 24, 2003

(30) Foreign Application Priority Data
Jan. 27, 2003 (TW) 092101761

(51) Int. Cl. H04L 12/28

(52) U.S. Cl. 370/402

(57) ABSTRACT

The present invention discloses a method of controlling bandwidth for a bridge device applied to packets transmitting between the bridge device and a companion chip. The method first calculates the traffic of packets received by the bridge device and adjusts the frequency of a clock signal that is generated by the bridge device. The clock signal is then outputted to the companion chip, and the companion chip adjusts the output bandwidth according to the clock signal. The bridge device will adjust the frequency of the clock signal when the storage ratio of the receiving queue is beyond a predetermined region and the predetermined region can be the region of the storage ratio between 20 and 80 percent. Additionally, the method of the present invention can be applied to the operation of transmitting packet from the bridge device to the companion chip.

### BACKGROUND OF THE INVENTION

1. Field of the Invention

The present invention relates to a method for controlling the bandwidth of a bridge device, and more particularly, to a method for controlling the bandwidth of a bridge device to transmit and receive packets by a programmable working clock.

2. Background of the Invention

A bridge device is used to connect local area networks (LAN) of the same type, or connect different local area networks. FIG. 1 illustrates a bridge device 10 connecting two local area networks 12 and 14. The bridge device 10 receives all packets transmitted on the local area network 12, and decides whether to forward a packet to the network 14 according to the destination address (DA) in the packet. If the destination address of the packet is inside the local area network 12, i.e., if this packet is transmitted to a workstation in the same local area network 12, the bridge device 10 will not forward this packet into the local area network 14 to avoid the wasting bandwidth of the local area network 14. If the destination address of the packet is inside the local area network 14, the bridge device 10 must use the communication protocol of the local area network 14 to forward this packet to the local area network 14 later. In other words, the bridge device 10 possesses the functions of “Filtering” and “Forwarding” packets, that is, the bridge device 10 filters packets transmitted in the same network and forwards packets transmitted to different networks.

FIG. 2 is a functional block diagram of the bridge device 10 according to the prior art. The bridge device comprises an embedded CPU 20, a system bus 22, a memory controller 32, and two ports 24, 26. The embedded CPU 20 can transform the format of a packet from one network into another format for another network. The memory controller 32 is responsible for controlling the access of an external memory 34. The port 24 is used to receive packets from and transmit packets to the local area network 14, and the port 26 is used to receive and transmit packets from and to the local area network 12. In other words, packets can be transmitted between the local area networks 12 and 14 via the ports 24, 26 and the system bus 22.

Since the bridge device 10 transmits and receive packets with a stationary working clock, a receive overrun and a transmit underrun occasionally occurs when the traffic between the local area networks 12 and 14 is very busy. The reason why the receive overrun and the transmit underrun occurs is because of the low processing speed of the embedded CPU 20 and the small bandwidth of the system bus 22. The high processing speed of embedded CPU is not considered due to power issue, and the big bandwidth of system bus is not considered due to chip area issue. Particularly, when the system bus is occupied by one port, the receive overrun and the transmit underrun will occur in other ports since there is no bandwidth of system bus 22 available, and the overall performance is dramatically influenced.

### SUMMARY OF THE INVENTION

The object of the present invention is to provide a method for controlling the bandwidth of a bridge device to avoid the occurrence of transmit underrun and receive overflow.

In order to achieve the above-mentioned object and avoid the problems of the prior art, the present invention provides a method for controlling the bandwidth of a bridge device applied to packets transmitting between the bridge device and a companion chip. The method first calculates the traffic of packets received by the bridge device and adjusts the frequency of a clock signal that is generated by the bridge device. The clock signal is then outputted to the companion chip, and the companion chip adjusts the output bandwidth according to the clock signal. The frequency of the clock signal is calculated according to a storage ratio of a receiving queue in the bridge device. The bridge device will adjust the frequency of the clock signal when the storage ratio of the receiving queue is beyond a predetermined region and the predetermined region can be the region of the storage ratio between 20 and 80 percent. When the traffic is higher than the predetermined region, the frequency of the clock signal is reduced to decrease the bandwidth used in transmitting packets from the companion chip to the bridge device. Additionally, the method of the present invention can be applied to the operation of transmitting packet from the bridge device to the companion chip.

Compared with the prior art, the present invention controls the bandwidth used in transmitting packets to and from the bridge device by adjusting the working clock of the companion chip, and the occurrence of receive overrun and transmit underrun is therefore effectively avoided.

### BRIEF DESCRIPTION OF THE DRAWINGS

Other objects and advantages of the present invention will become apparent upon reading the following description and upon reference to the accompanying drawings in which:

FIG. 1 is a schematic diagram of a bridge device connecting two local area networks according to the prior art;

FIG. 2 is a functional block diagram of a bridge device according to the prior art;

FIG. 3 is a functional block diagram of a bridge device according to the present invention; and

FIG. 4(a) and FIG. 4(b) are schematic diagrams showing the method for controlling the bandwidth of a bridge device according to the present invention.

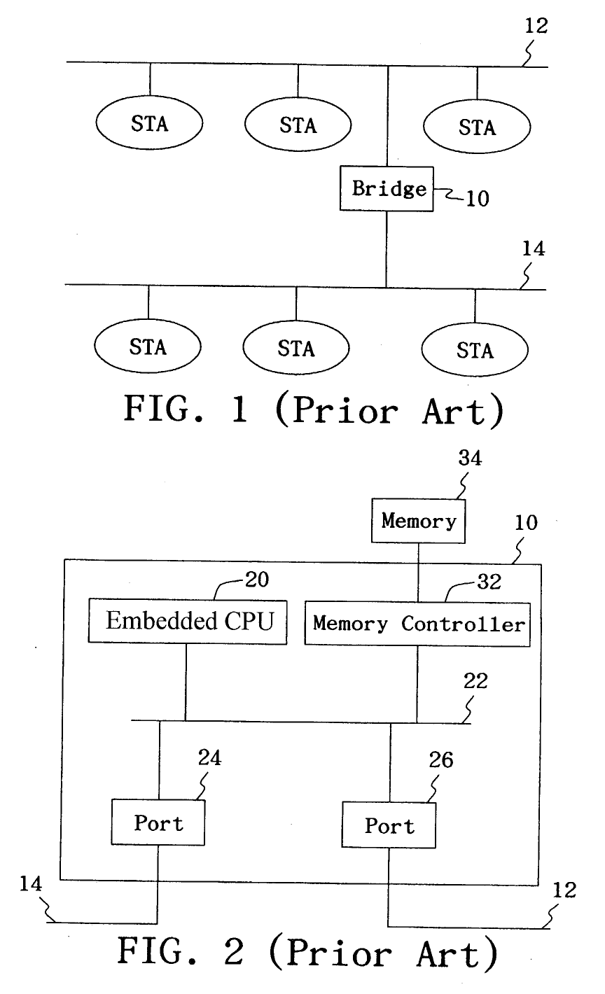

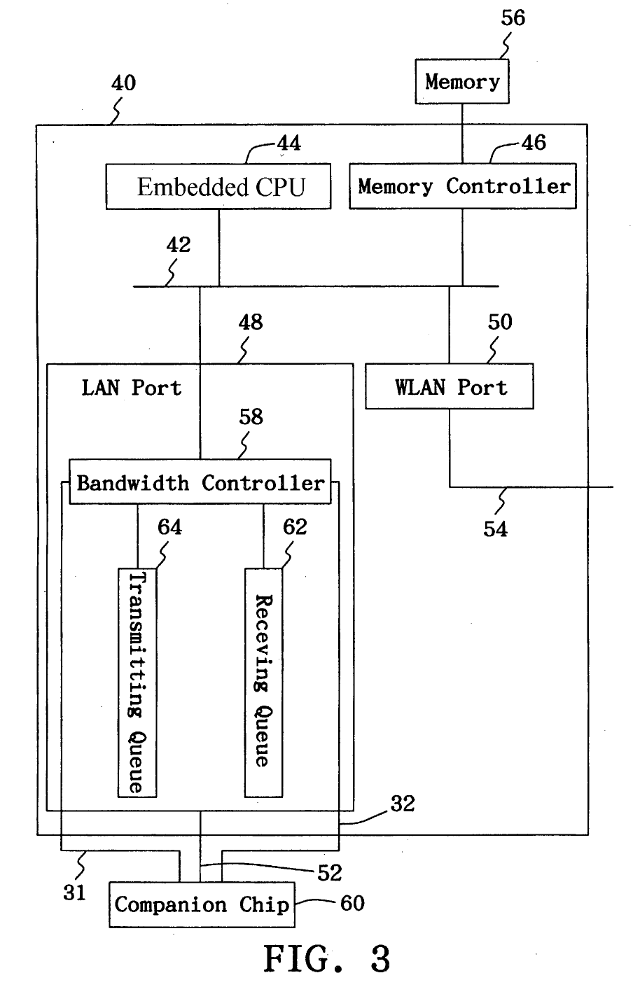

### PREFERRED EMBODIMENT OF THE PRESENT INVENTION

FIG. 3 is a functional block diagram of a bridge device 40 according to the present invention. The bridge device 40 comprises a system bus 42, an embedded CPU 44 electrically connected to the system bus 42, a memory controller 46 electrically connected to the system bus 42, and two ports 48, 50. The port 48 is used to transmit and receive packets to and from the local area network 52, and the port 50 is used to transmit and receive packets to and from the wireless local area network 54.

The embedded CPU 44 is responsible for transforming the format of the packet, for example, transforming the format from the local area network 52 into a format suitable for use in the wireless local area network 54. The memory controller 46 is used to control the access of an external memory 56. The port 48 comprises a bandwidth controller 58, a receiving queue 62 and a transmitting queue 64. The receiving queue 62 and the transmitting queue 64 are first-in first-out (FIFO) data memory or buffer.

The bandwidth controller 58 is responsible for controlling the bandwidth used in transmitting the packets between the bridge device 40 and a companion chip 60 which is a multi-port switch, and one of these ports is electrically connected to the bridge device 40 via a Media Independent Interface (MII). According to the receiving clock signal (RXCLK) 31 transmitted from the bandwidth controller 58 to the companion chip 60, the companion chip 60 will adjust the bandwidth used in transmitting packets to the bridge device 40. Relatively, according to the transmitting clock signal (TXCLK) 32, the companion chip 60 adjusts the bandwidth for receiving packets from the bridge device 40.

Packets transmitted from the companion chip 60 to the bridge device 40 are registered temporarily in the receiving queue 62. It is then removed to store in the external memory 56 through the system bus 42 and the memory controller 46. When a packet is to be transmitted from the bridge device 40 to the companion chip 60, the packet is removed from the external memory 56, registers temporarily in the transmitting queue 64, and finally is transmitted to the companion chip 60 from the transmitting queue 64.

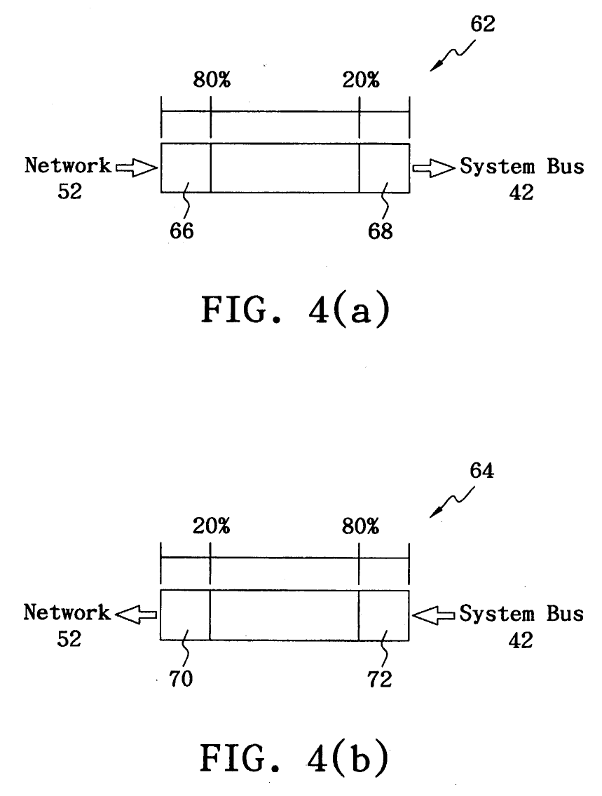

FIG. 4(a) and FIG. 4(b) are schematic diagrams showing the method for controlling the bandwidth according to the present invention. With reference to FIG. 4(a), when the storage ratio of the receiving queue 62 exceeds 80%, i.e., when the subsequent received packets from the companion chip 60 is to be stored in the region 66, the bandwidth controller 58 will decrease the frequency of the receiving clock signal 31 and output this decreased receiving clock signal 31 to the companion chip 60. On receiving the decreased receiving clock signal 31, the companion chip 60 will decrease the bandwidth used in transmitting the packets to the bridge device 40 to reduce the traffic of the receiving queue 62. As a result, since the input of the receiving queue 62 from the network 52 is decreased and the receiving queue 62 can use the system bus 42 continually to output packets to the external memory 56, the occurrence of receive overrun can be avoided.

When the storage ratio of the receiving queue 62 is below 20%, i.e., when the subsequent received packets from the companion chip 60 is to be stored in the region 68, the bandwidth controller 58 will increase the frequency of the receiving clock signal 31 and output this increased receiving clock signal 31 to the companion chip 60. On receiving the increased receiving clock signal 31, the companion chip 60 will increase the bandwidth used in transmitting the packets to the bridge device 40 to increase the traffic of the receiving queue 62.

Referring now to FIG. 4(b), when the storage ratio of the transmitting queue 64 is below 20%, i.e., when the subsequent received packets from the system bus 42 is to be stored in the region 70, the bandwidth controller 58 will decrease the frequency of a transmitting clock signal 32 and output this decreased transmitting clock signal 32 to the companion chip 60. On receiving the decreased transmitting clock signal 32, the companion chip 60 decreases the bandwidth for receiving packets from the bridge device 40 to reduce the traffic of the transmitting queue 64. As a result, since the output of the transmitting queue 64 is reduced and packets to be transmitted can be input to the transmitting queue 64 through the system bus 42, the occurrence of the transmit underrun can be avoided.

When the storage ratio of the transmitting queue 64 exceeds 80%, i.e., when the subsequent received packets from the system bus 42 is to be stored in the region 72, the bandwidth controller 58 will increase the frequency of the transmitting clock signal 32 and output this increased clock signal 32 to the companion chip 60. On receiving the increased transmitting clock signal 32, the companion chip 60 will increase the bandwidth used in receiving the packets from the bridge device 40 to increase the traffic of the transmitting queue 64.

Compared with the prior art, the present invention controls the bandwidth used in transmitting packets to the bridge device and the bandwidth used in receiving packets from the bridge device by adjusting the working clock of the companion chip. Therefore, the occurrence of receive overrun and transmit underrun is effectively avoided.

The above-described embodiments of the present invention are intended to be illustrative only. Numerous alternative embodiments may be devised by those skilled in the art without departing from the scope of the following claims.

What is claimed is:

1. A method for controlling the bandwidth of a bridge device, applied to packet transmission between the bridge device and a companion chip, the method comprising the steps of:
calculating a traffic of packets received by the bridge device;
adjusting the frequency of a clock signal which is generated by the bridge device and outputted to the companion chip according to the traffic of packets; and
adjusting the output bandwidth of the companion chip according to the frequency of the clock signal.

2. The method for controlling the bandwidth of a bridge device of claim 1, wherein the traffic of packets received by the bridge device is determined by a storage ratio of a receiving queue in the bridge device.

3. The method for controlling the bandwidth of a bridge device of claim 2, wherein the bridge device decreases the frequency of the clock signal when the storage ratio of the receiving queue exceeds a predetermined value so that the output bandwidth of the companion chip is decreased.

4. The method for controlling the bandwidth of a bridge device of claim 3, wherein the predetermined value is 80 percent.

5. The method for controlling the bandwidth of a bridge device of claim 2, wherein the bridge device increases the frequency of the clock signal when the storage ratio of the receiving queue is below a predetermined value so that the output bandwidth of the companion chip is increased.

6. The method for controlling the bandwidth of a bridge device of claim 5, wherein the predetermined value is 20 percent.

7. A method for controlling the bandwidth of a bridge device, applied to packet transmission between the bridge device and a companion chip, the method comprising the steps of:
calculating a traffic of packets transmitted by the bridge device;
adjusting the frequency of a clock signal which is generated by the bridge device and outputted to the companion chip according to the traffic of packets; and
adjusting the input bandwidth of the companion chip according to the frequency of the clock signal.

8. The method for controlling the bandwidth of a bridge device of claim 7, wherein the traffic of transmitting packets from the bridge device is determined by a storage ratio of a transmitting queue in the bridge device.

9. The method for controlling the bandwidth of a bridge device of claim 8, wherein the bridge device increases the frequency of the clock signal when the storage ratio of the transmitting queue excesses a predetermined value so that the input bandwidth of the companion chip is increased.

10. The method for controlling the bandwidth of a bridge device of claim 9, wherein the predetermined value is 80 percent.

11. The method for controlling the bandwidth of a bridge device of claim 8, wherein the bridge device decreases the frequency of the clock signal when the storage ratio of the transmitting queue is below a predetermined value so that the input bandwidth of the companion chip is decreased.

12. The method for controlling the bandwidth of a bridge device of claim 11, wherein the predetermined value is 20 percent.
